(19) United States
(12) Patent Application Publication
(10) Pub. No.: US 2024/0095541 A1
(43) Pub. Date: Mar. 21, 2024

(54) COMPILING OF TASKS FOR STREAMING OPERATIONS AT NEURAL PROCESSOR

(71) Applicant: Apple Inc., Cupertino, CA (US)

(72) Inventors: Sayyed Karen Khatamifard, Bellevue, WA (US); Thomas G. Anderl, Seattle, WA (US); Alexander J. Kirchhoff, Seattle, CA (US); Keith Wyss, Seattle, WA (US); Dylan H. Rush, Mountlake Terrace, WA (US); Chenfan Sun, SHORELINE, WA (US); Jeffrey D Marker, Pleasant View, UT (US)

(21) Appl. No.: 17/946,409

(22) Filed: Sep. 16, 2022

(51) Int. Cl. G06N 3/10; G06N 3/063

(52) U.S. Cl. CPC G06N 3/10; G06N 3/063

(57) ABSTRACT

Embodiments relate to compiling neural network operations into tasks that may be performed in a streaming manner by a neural processor. In a streaming operation, a tensor is spatially partitioned, and tasks associated two or more layers of the neural network are performed simultaneously in an overlapping manner. To enable efficient memory usage during streaming operation, a subset of the tasks having completion times close in time are assigned to a same portion of memory in the neural processor during a compilation process. After the tasks assigned to the same portion of the memory is finished, the portion of the memory may be flushed to make space for subsequent tasks. Multiple tasks may also be coalesced into a single task to reduce the number of tasks and more efficiently perform the operations at the neural processor.

### BACKGROUND

### 1. Field of the Disclosure

The present disclosure relates to scheduling operations associated with neural networks, and more specifically to compiling operations of multiple tensor layers in a neural network into tasks that may be performed by a neural processor in a streaming manner.

### 2. Description of the Related Arts

An artificial neural network (ANN) is a computing system or model that uses a collection of connected nodes to process input data. The ANN is typically organized into layers where different layers perform different types of transformation on their input. Extensions or variants of ANN such as convolution neural network (CNN), recurrent neural networks (RNN) and deep belief networks (DBN) have come to receive much attention. These computing systems or models often involve extensive computing operations including multiplication and accumulation. For example, CNN is a class of machine learning technique that primarily uses convolution between input data and kernel data, which can be decomposed into multiplication and accumulation operations.

Depending on the types of input data and operations to be performed, these machine learning systems or models can be configured differently. Such varying configuration would include, for example, pre-processing operations, the number of channels in input data, kernel data to be used, non-linear function to be applied to convolution result, and applying of various post-processing operations. Using a central processing unit (CPU) and its main memory to instantiate and execute machine learning systems or models of various configuration is relatively easy because such systems or models can be instantiated with mere updates to code. However, relying solely on the CPU for various operations of these machine learning systems or models would consume significant bandwidth of the CPU as well as increase the overall power consumption.

### SUMMARY

Embodiments relate to compiling neural network operations into tasks to be performed in a streaming manner by a neural processor. In a compilation process, a compiler determines spatial segmentation of a first tensor and a second tensor associated with a neural network. The spatial segmentation divides the first tensor and the second tensor into a plurality of partitions is determined. The second tensor is derived by performing convolution on the first tensor by a neural processor. Dependencies of tasks, each corresponding to one or more of the plurality of partitions are determined. A first task schedule of the tasks that satisfies the dependencies of the tasks is generated. A first subset of the tasks, that have completion times at the neural processor satisfying a first timing constraint, is allocated to a same first portion of a memory in the neural processor for storage.

In some embodiments, a first subset of tasks that have completion times within a first time frame are allocated a first portion of the buffer memory for storage, and a second subset of tasks that have completion times within a second time frame are allocated a second portion of the buffer memory for storage. The data processor circuit releases the first portion of the buffer memory after an end of the first time frame when the first subset of tasks are completed, and releases the second portion of the buffer memory after an end of the second time frame when the second subset of tasks are completed.

In some embodiments, a number of partitions in each task is adjusted according to a hardware configuration of the neural processor. The hardware configuration may be associated with a size of a memory in the neural processor.

In some embodiments, adjusting the number of partitions in each task includes coalescing two or more of the tasks to generate updated tasks, determining dependencies of the updated tasks, and generating a second task schedule of the updated tasks that satisfies the dependencies of the updated tasks.

### BRIEF DESCRIPTION OF THE DRAWINGS

FIG. 1 is a high-level diagram of an electronic device, according to one embodiment.

FIG. 2 is a block diagram illustrating components in the electronic device, according to one embodiment.

FIG. 3 is a block diagram illustrating a neural processor circuit, according to one embodiment.

FIG. 4A is a block diagram of a neural engine in the neural processor circuit, according to one embodiment.

FIG. 4B illustrates an example convolution operation performed in a streaming manner at the neural engine of FIG. 4A, according to one embodiment.

FIG. 5 illustrates an example of performing convolution operations on multiple convolution layers in a streaming manner, according to one embodiment.

FIG. 6A is a block diagram of a neural task manager of the neural processor circuit, according to one embodiment.

FIG. 6B illustrates an example of task memory in the neural task manager of FIG. 6A, according to one embodiment.

FIG. 7 is a block diagram of a compiler that may be implemented at a data processor circuit of a neural processor circuit, according to one embodiment.

FIG. 8 illustrates an example of spatial segmentation of a tensor, according to one embodiment.

FIGS. 9A and 9B illustrate an example of dependency relationship among partitions in different layers, according to one embodiment.

FIG. 10 illustrates an example dependency graph representing dependency relationships among partitions or tasks in multiple tensor layers, according to one embodiment.

FIG. 11 illustrates an example of buffer allocation among tasks in different tensor layers, according to one embodiment.

FIGS. 12A-12C illustrate examples of allocating portions of buffer memory for storing tasks corresponding to tasks shown in FIG. 11, according to one embodiment.

FIG. 13 is a flowchart illustrating a method of compiling operations into a plurality of tasks to be performed by a neural processor circuit in a streaming manner, according to one embodiment.

FIG. 14 is a flowchart illustrating another method of compiling operations into a plurality of tasks to be performed by a neural engine circuit in a streaming manner, according to one embodiment.

The figures depict, and the detailed description describes, various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments relate to compiling neural network operations into tasks that may be performed in a streaming manner by a neural processor. In a streaming operation, a tensor is spatially partitioned, and tasks associated two or more layers of the neural network are performed simultaneously in an overlapping manner. To enable efficient memory usage during streaming operation, a subset of the tasks having completion times close in time are assigned to a same portion of memory in the neural processor during a compilation process. After the tasks assigned to the same portion of the memory is finished, the portion of the memory may be flushed to make space for subsequent tasks. Multiple tasks may also be coalesced into a single task to reduce the number of tasks and more efficiently perform the operations at the neural processor.

### Exemplary Electronic Device

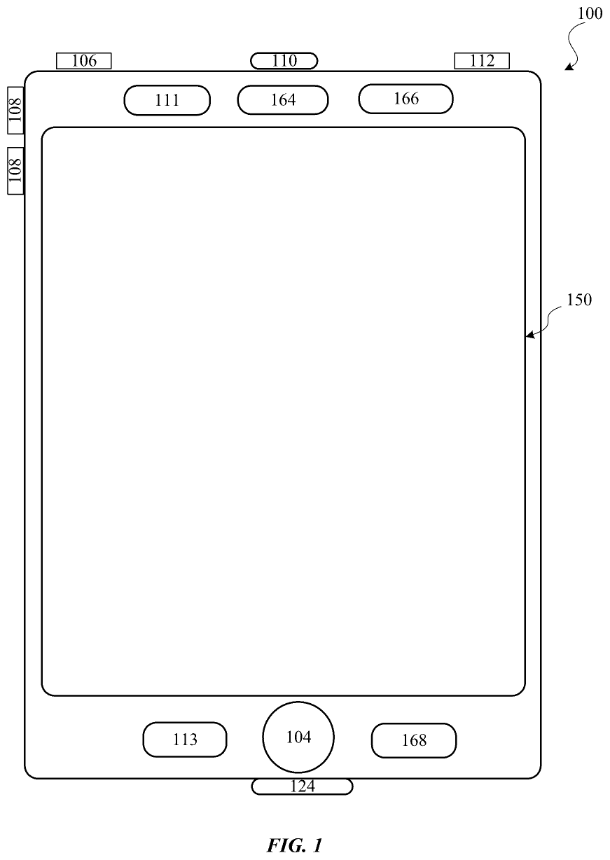

Embodiments of electronic devices, user interfaces for such devices, and associated processes for using such devices are described. In some embodiments, the device is a portable communications device, such as a mobile telephone, that also contains other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, California. Other portable electronic devices, such as wearables, laptops or tablet computers, are optionally used. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with Figure (FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to one embodiment. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, headset jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 includes various components including, but not limited to, a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include more than one type of image sensors 164. Each type may include more than one image sensor 164. For example, one type of image sensors 164 may be cameras and another type of image sensors 164 may be infrared sensors for facial recognition that is performed by one or more machine learning models stored in device 100. Device 100 may include components not shown in FIG. 1 such as an ambient light sensor, a dot projector and a flood illuminator that is to support facial recognition.

Device 100 is only one example of an electronic device, and device 100 may have more or fewer components than listed above, some of which may be combined into a component or have a different configuration or arrangement. The various components of device 100 listed above are embodied in hardware, software, firmware or a combination thereof, including one or more signal processing and/or application-specific integrated circuits (ASICs).

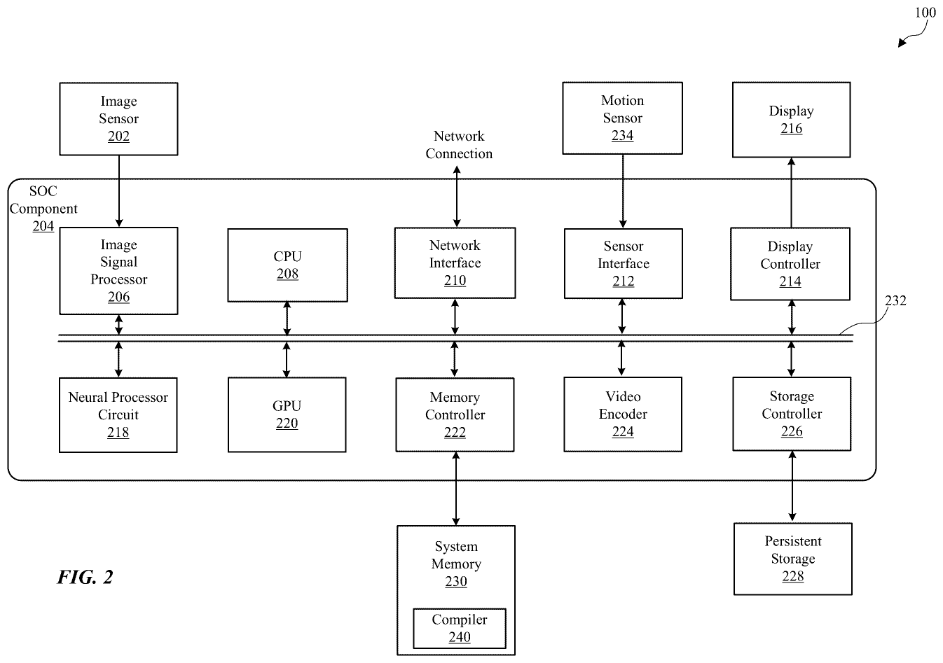

FIG. 2 is a block diagram illustrating components in device 100, according to one embodiment. Device 100 may perform various operations including implementing one or more machine learning models. For this and other purposes, device 100 may include, among other components, image sensors 202, a system-on-a chip (SOC) component 204, a system memory 230, a persistent storage (e.g., flash memory) 228, a motion sensor 234, and a display 216. The components as illustrated in FIG. 2 are merely illustrative. For example, device 100 may include other components (such as speaker or microphone) that are not illustrated in FIG. 2. Further, some components (such as motion sensor 234) may be omitted from device 100.

An image sensor 202 is a component for capturing image data and may be embodied, for example, as a complementary metal-oxide-semiconductor (CMOS) active-pixel sensor) a camera, video camera, or other devices. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color kernel array (CFA) pattern.

Motion sensor 234 is a component or a set of components for sensing motion of device 100. Motion sensor 234 may generate sensor signals indicative of orientation and/or acceleration of device 100. The sensor signals are sent to SOC component 204 for various operations such as turning on device 100 or rotating images displayed on display 216.

Display 216 is a component for displaying images as generated by SOC component 204. Display 216 may include, for example, liquid crystal display (LCD) device or an organic light-emitting diode (OLED) device. Based on data received from SOC component 204, display 216 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof.

Persistent storage 228 is a component for storing data in a non-volatile manner. Persistent storage 228 retains data even when power is not available. Persistent storage 228 may be embodied as read-only memory (ROM), flash memory or other non-volatile random access memory devices. Persistent storage 228 stores an operating system of device 100 and various software applications. Persistent storage 228 may also store one or more machine learning models, such as regression models, random forest models, support vector machines (SVMs) such as kernel SVMs, and artificial neural networks (ANNs) such as convolutional network networks (CNNs), recurrent network networks (RNNs), autoencoders, and long short term memory (LSTM). A machine learning model may be an independent model that works with the neural processor circuit 218 and various software applications or sensors of device 100. A machine learning model may also be part of a software application. The machine learning models may perform various tasks such as facial recognition, image classification, object, concept, and information classification, speech recognition, machine translation, voice recognition, voice command recognition, text recognition, text and context analysis, other natural language processing, predictions, and recommendations.

Various machine learning models stored in device 100 may be fully trained, untrained, or partially trained to allow device 100 to reinforce or continue to train the machine learning models as device 100 is used. Operations of the machine learning models include various computation used in training the models and determining results in runtime using the models. For example, in one case, device 100 captures facial images of the user and uses the images to continue to improve a machine learning model that is used to lock or unlock the device 100.

SOC component 204 is embodied as one or more integrated circuit (IC) chip and performs various data processing processes. SOC component 204 may include, among other subcomponents, image signal processor (ISP) 206, a central processor unit (CPU) 208, a network interface 210, sensor interface 212, display controller 214, neural processor circuit 218, graphics processor (GPU) 220, memory controller 222, video encoder 224, storage controller 226, and bus 232 connecting these subcomponents. SOC component 204 may include more or fewer subcomponents than those shown in FIG. 2.

ISP 206 is a circuit that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations.

CPU 208 may be embodied using any suitable instruction set architecture, and may execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

GPU 220 is graphics processing circuitry for performing graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

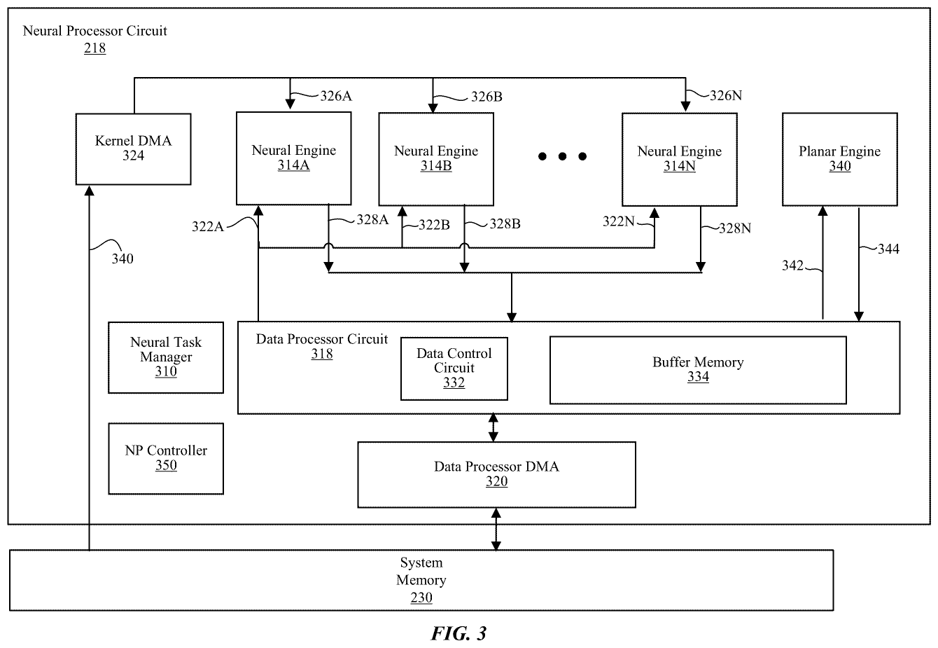

Neural processor circuit 218 is a circuit that performs various machine learning operations based on computation including multiplication, addition, and accumulation. Such computation may be arranged to perform, for example, various types of tensor multiplications such as tensor product and convolution of input data and kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 212, ISP 206, persistent storage 228, system memory 230 or other sources such as network interface 210 or GPU 220. The output of neural processor circuit 218 may be provided to various components of device 100 such as ISP 206, system memory 230 or CPU 208 for various operations. The structure and operation of neural processor circuit 218 are described below in detail with reference to FIG. 3.

Network interface 210 is a subcomponent that enables data to be exchanged between devices 100 and other devices via one or more networks (e.g., carrier or agent devices). For example, video or other image data may be received from other devices via network interface 210 and be stored in system memory 230 for subsequent processing (e.g., via a back-end interface to ISP 206) and display. The networks may include, but are not limited to, Local Area Networks (LANs) (e.g., an Ethernet or corporate network) and Wide Area Networks (WANs). The image data received via network interface 210 may undergo image processing processes by ISP 206.

Sensor interface 212 is circuitry for interfacing with motion sensor 234. Sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 is hardware, software, firmware or a combination thereof for encoding video data into a format suitable for storing in persistent storage 228 or for passing the data to network interface 210 for transmission over a network to another device.

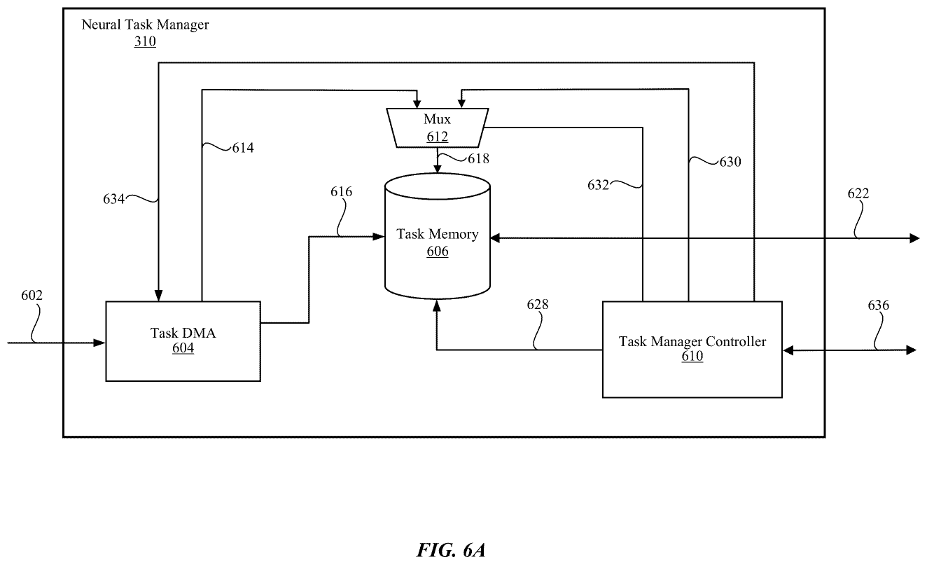

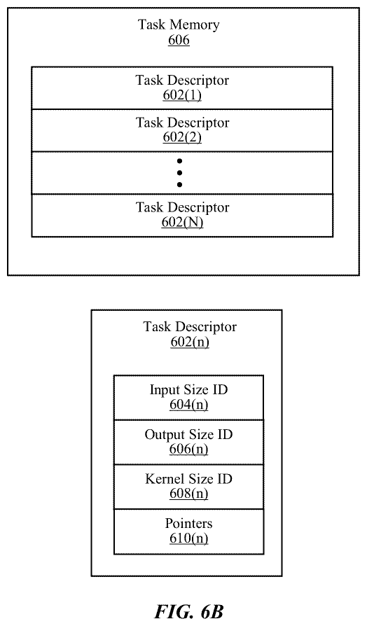

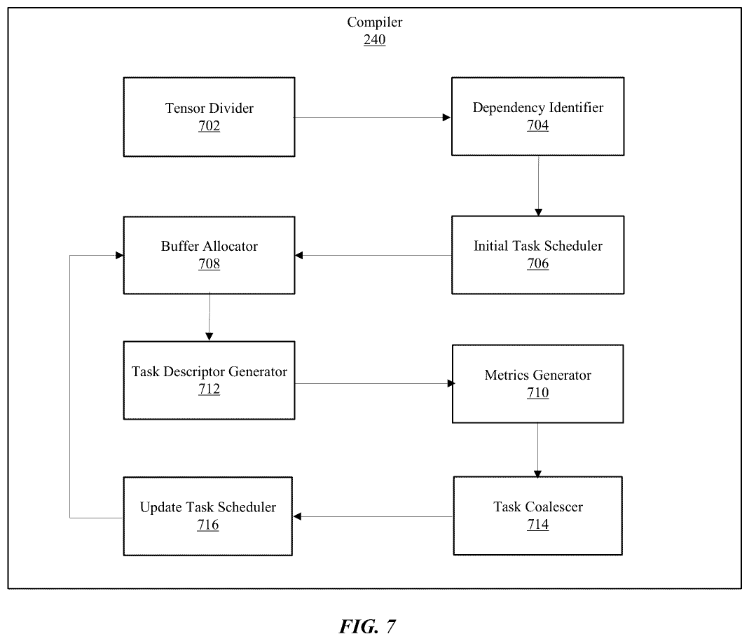

Compiler 240 may be software for performing compiling operations associated with neural networks. Compiler 240 may be a code module stored, for example, in system memory 230. When compiler 240 is executed, for example, by CPU 280, a task schedule listing the task descriptors of tasks to be performed by neural engines in neural processor circuit 218 is generated, as described below in detail with reference to FIG. 6B. The details of compiler 240 and its operation are described below in detail with reference to FIGS. 7-11. In other embodiments, compiler 240 may be embodied as a combination of software, hardware or firmware.

In some embodiments, one or more subcomponents of SOC component 204 or some functionality of these subcomponents may be performed by software components executed on neural processor circuit 218, ISP 206, CPU 208 or GPU 220. Such software components may be stored in system memory 230, persistent storage 228 or another device communicating with device 100 via network interface 210.

### Example Neural Processor Circuit

Neural processor circuit 218 is a programmable circuit that performs machine learning operations on the input data of neural processor circuit 218. Machine learning operations may include different computations for training of a machine learning model and for performing inference or prediction based on the trained machine learning model.

Taking an example of a CNN as the machine learning model, training of the CNN may include forward propagation and backpropagation. A neural network may include an input layer, an output layer, and one or more intermediate layers that may be referred to as hidden layers. Each layer may include one or more nodes, which may be fully or partially connected to other nodes in adjacent layers. In forward propagation, the neural network performs computation in the forward direction based on outputs of a preceding layer. The operation of a node may be defined by one or more functions. The functions that define the operation of a node may include various computation operation such as convolution of data with one or more kernels, pooling of layers, tensor multiplication, etc. The functions may also include an activation function that adjusts the weight of the output of the node. Nodes in different layers may be associated with different functions. For example, a CNN may include one or more convolutional layers that are mixed with pooling layers and are followed by one or more fully connected layers.

Each of the functions, including kernels, in a machine learning model may be associated with different coefficients that are adjustable during training. In addition, some of the nodes in a neural network each may also be associated with an activation function that decides the weight of the output of the node in a forward propagation. Common activation functions may include step functions, linear functions, sigmoid functions, hyperbolic tangent functions (tan h), and rectified linear unit functions (ReLU). After a batch of data of training samples passes through a neural network in the forward propagation, the results may be compared to the training labels of the training samples to compute the network's loss function, which represents the performance of the network. In turn, the neural network performs backpropagation by using coordinate descent such as stochastic coordinate descent (SGD) to adjust the coefficients in various functions to improve the value of the loss function.

In training, device 100 may use neural processor circuit 218 to perform all or some of the operations in the forward propagation and backpropagation. Multiple rounds of forward propagation and backpropagation may be performed by neural processor circuit 218, solely or in coordination with other processors such as CPU 208, GPU 220, and ISP 206. Training may be completed when the loss function no longer improves (e.g., the machine learning model has converged) or after a predetermined number of rounds for a particular set of training samples. As device 100 is used, device 100 may continue to collect additional training samples for the neural network.

For prediction or inference, device 100 may receive one or more input samples. Neural processor circuit 218 may take the input samples to perform forward propagation to determine one or more results. The input samples may be images, speeches, text files, sensor data, or other data.

Data and functions (e.g., input data, kernels, functions, layers outputs, gradient data) in machine learning may be saved and represented by one or more tensors. Common operations related to training and runtime of a machine learning model may include tensor product, tensor transpose, tensor elementwise operation, convolution, application of an activation function, automatic differentiation to determine gradient, statistics and aggregation of values in tensors (e.g., average, variance, standard deviation), tensor rank and size manipulation, etc.

While the training and runtime of a neural network is discussed as an example, neural processor circuit 218 may also be used for the operations of other types of machine learning models, such as a kernel SVM.

Referring to FIG. 3, an example neural processor circuit 218 may include, among other components, a neural task manager 310, neural engines 314A through 314N (hereinafter collectively referred as “neural engines 314” and individually also referred to as “neural engine 314”), a kernel direct memory access (DMA) 324, a data processor circuit 318, a data processor DMA 320, and a planar engine 340. Neural processor circuit 218 may include fewer or additional components not illustrated in FIG. 3.

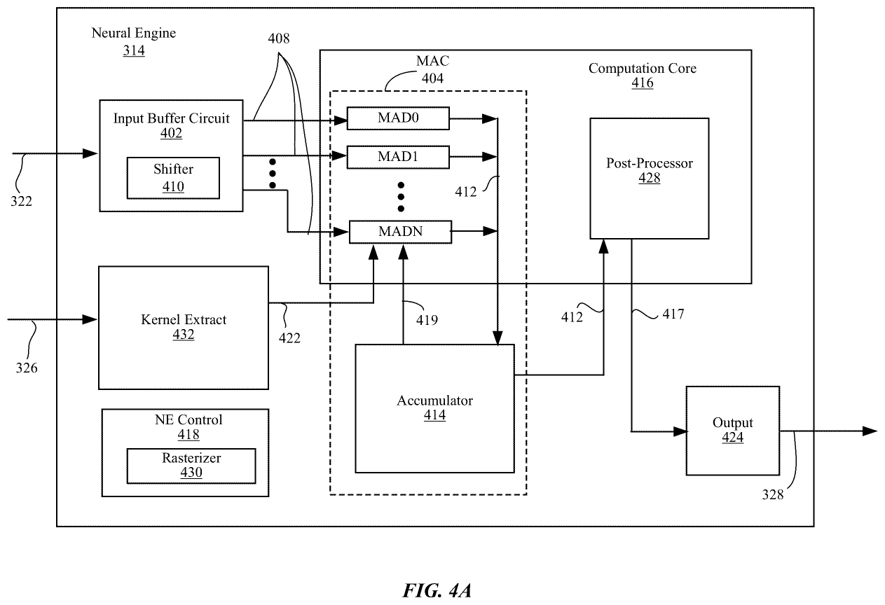

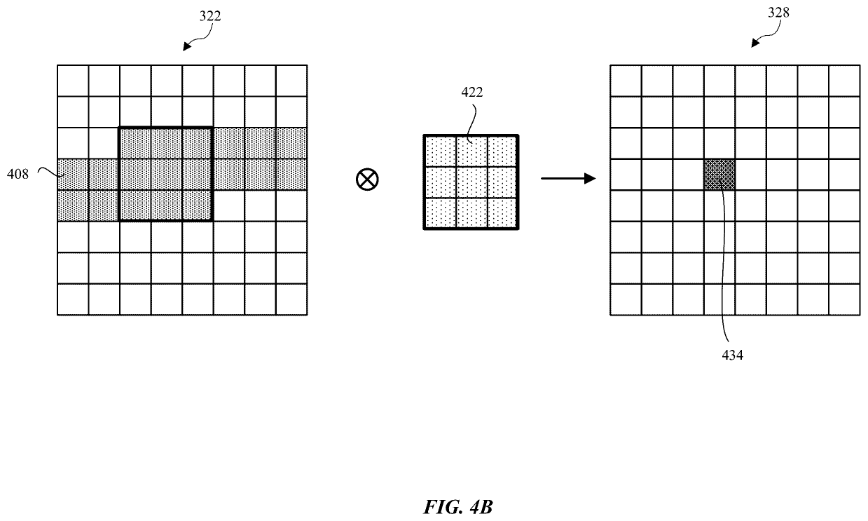

Each of neural engines 314 performs computing operations for machine learning in parallel. Depending on the load of operation, the entire set of neural engines 314 may be operating or only a subset of the neural engines 314 may be operating while the remaining neural engines 314 are placed in a power-saving mode to conserve power. Each of neural engines 314 includes components for storing one or more kernels, for performing multiply-accumulate operations, and for post-processing to generate an output data 328, as described below in detail with reference to FIG. 4A. Neural engines 314 may specialize in performing computation heavy operations such as convolution operations and tensor product operations. Convolution operations may include different kinds of convolutions, such as cross-channel convolutions (a convolution that accumulates values from different channels), channel-wise convolutions, and transposed convolutions. Different neural engines 314 may process different tensor inputs. Alternatively, one neural engine 314 may process different tensor inputs.

Planar engine 340 may specialize in performing simpler computing operations whose speed may primarily depend on the input and output (I/O) speed of the data transmission instead of the computation speed within planar engine 340. Those computing operations may be referred to as I/O bound computations. In contrast, neural engines 314 may focus on complex computation whose speed may primarily depend on the computation speed within each neural engine 314. For example, planar engine 340 is efficient at performing operations within a single channel while neural engines 314 are efficient at performing operations across multiple channels that may involve heavy accumulation of data. The use of neural engine 314 to compute I/O bound computations may not be efficient in terms of both speed and power consumption. In one embodiment, input data may be a tensor whose rank is larger than three (e.g., having three or more dimensions). A set of dimensions (two or more) in the tensor may be referred to as a plane while another dimension may be referred to as a channel. Neural engines 314 may convolve data of a plane in the tensor with a kernel and accumulate results of the convolution of different planes across different channels. On the other hand, planar engine 340 may specialize in operations within the plane.

The circuitry of planar engine 340 may be programmed for operation in one of multiple modes, including a pooling mode, an elementwise mode, and a reduction mode. In the pooling mode, planar engine 340 reduces a spatial size of input data. In the elementwise mode, planar engine 340 generates an output that is derived from elementwise operations of one or more inputs. In the reduction mode, planar engine 340 reduces the rank of a tensor. For example, a rank 5 tensor may be reduced to a rank 2 tensor, or a rank 3 tensor may be reduced to a rank 0 tensor (e.g., a scalar). In some embodiments, planar engine 340 is omitted from neural processor circuit 218.

Neural task manager 310 manages the overall operation of neural processor circuit 218. Neural task manager 310 may receive a task list from a compiler executed by CPU 208, store tasks in its task queues, choose a task to perform, and send task commands to other components of neural processor circuit 218 for performing the chosen task. Data may be associated with a task command that indicates the types of operations to be performed on the data. Data of neural processor circuit 218 includes input data that is transmitted from another source such as system memory 230, and data generated by neural processor circuit 218 in a previous operating cycle. Each dataset may be associated with a task command that specifies the type of operations to be performed on the data. Neural task manager 310 may also perform switching of tasks on detection of events such as receiving instructions from CPU 208. In one or more embodiments, neural task manager 310 sends rasterizer information to the components of neural processor circuit 218 to enable each of the components to track, retrieve or process appropriate segments of the input data and kernel data. For example, neural task manager 310 may include registers that stores the information regarding the size and rank of a dataset for processing by neural processor circuit 218. Although neural task manager 310 is illustrated in FIG. 3 as part of neural processor circuit 218, neural task manager 310 may be a component outside neural processor circuit 218.

Kernel DMA 324 is a read circuit that fetches kernel data from a source (e.g., system memory 230) and sends kernel data 326A through 326N to each of neural engines 314. Kernel data represents information from which kernel elements can be extracted. In one embodiment, the kernel data may be in a compressed format which is decompressed at each of neural engines 314. Although kernel data provided to each of neural engines 314 may be the same in some instances, the kernel data provided to each of neural engines 314 is different in most instances. In one embodiment, the direct memory access nature of kernel DMA 324 may allow kernel DMA 324 to fetch and write data directly from the source without the involvement of CPU 208.

Data processor circuit 318 manages data traffic and task performance of neural processor circuit 218. Data processor circuit 318 may include a data control circuit 332 and a buffer memory 334. Buffer memory 334 is temporary storage for storing data associated with operations of neural processor circuit 218 and planar engine 340, such as input data that is transmitted from system memory 230 (e.g., data from a machine learning model) and other data that is generated within neural processor circuit 218 or planar engine 340. The data stored in data processor circuit 318 may include different subsets that are sent to various downstream components, such as neural engines 314 and planar engine 340.

In one embodiment, buffer memory 334 is embodied as a non-transitory memory that can be accessed by neural engines 314 and planar engine 340. Buffer memory 334 may be a direct memory access buffer that stores data of a machine learning model of device 100 without involvement of CPU 208. Buffer memory 334 may store input data 322A through 322N for feeding to corresponding neural engines 314A through 314N or planar engine 340, as well as output data 328A through 328N from each of neural engines 314A through 314N or planar engine 340 for feeding back into one or more neural engines 314 or planar engine 340, or sending to a target circuit (e.g., system memory 230). Buffer memory 334 may also store input data 342 and output data 344 of planar engine 340 and allow the exchange of data between neural engine 314 and planar engine 340. For example, one or more output data 328A through 328N of neural engines 314 are used as input data 342 to planar engine 340. Likewise, output data 344 of planar engine 340 may be used as input data 322A through 322N of neural engines 314. The inputs of neural engines 314 or planar engine 340 may be any data stored in buffer memory 334. For example, in various operating cycles, the source datasets from which one of the engines fetches as inputs may be different. The input of an engine may be an output of the same engine in previous operating cycles, outputs of different engines, or any other suitable source datasets stored in buffer memory 334. Also, a dataset in buffer memory 334 may be divided and sent to different engines for different operations in the next operating cycle. Two datasets in buffer memory 334 may also be joined for the next operation.

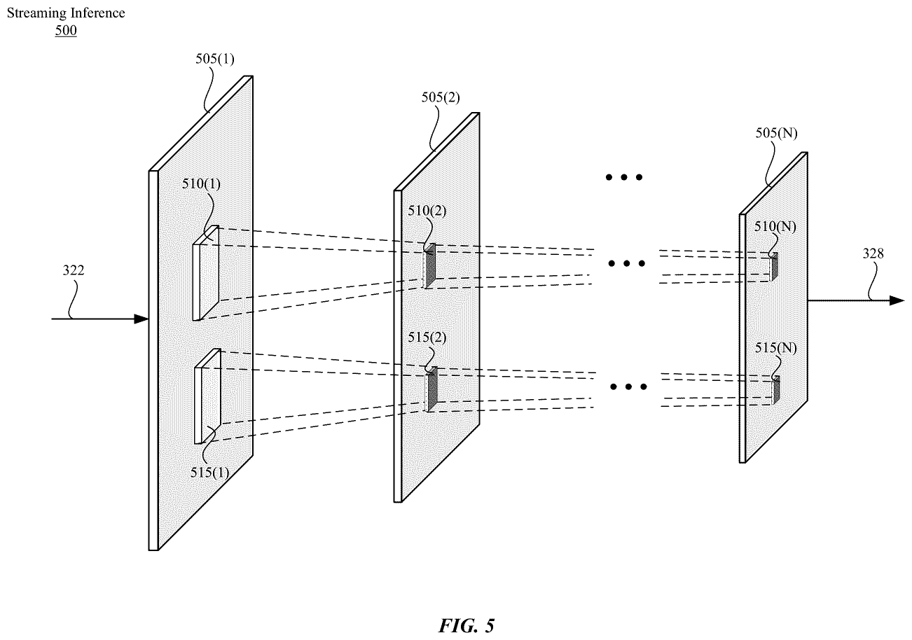

Buffer memory 334 may include multiple tensor buffers for storing portions of input data 322A through 322N and portions of output data 328A through 328N for access by one or more neural engines 314 to perform the streaming convolution operations. Details about structure and operations of buffer memory 334 for supporting the streaming convolution operations at one or more neural engines 314 are described below in with reference to FIGS. 5, 6A, and 6B.

Data control circuit 332 of data processor circuit 318 may control the exchange of data between neural engines 314 and planar engine 340. The operations of data processor circuit 318 and other components of neural processor circuit 218 are coordinated so that the input data and intermediate data stored in data processor circuit 318 may be reused across multiple operations at neural engines 314 and planar engine 340, thereby reducing data transfer to and from system memory 230. Data control circuit 332 may perform one or more of the following operations: (i) monitor the size and rank of data (e.g. data may be one or more tensors) that are being processed by neural engines 314 and planar engine 340, (ii) determine which subsets of data are transmitted to neural engines 314 or to planar engine 340 based on the task commands associated with different subsets of data, (iii) determine the manner in which data is transmitted to neural engines 314 and planar engine 340 (e.g., data processor circuit 318 may operate in a broadcast mode where the same data is fed to multiple input channels of neural engines 314 so that multiple or all neural engines 314 receive the same data or in a unicast mode where different neural engines 314 receives different data), and (iv) transmit a configuration command to planar engine 340 to direct planar engine 340 to program itself for operating in one of multiple operation modes. Details about operations of data control circuit 332 are described below in with reference to FIGS. 5, 6A, and 6B.

The data of neural processor circuit 218 stored in buffer memory 334 may be part of, among others, image data, histogram of oriented gradients (HOG) data, audio data, metadata, output data 328 of a previous operating cycle of neural engine 314, and other processed data received from other components of SOC component 204.

Data processor DMA 320 includes a read circuit that receives a portion of input data from a source (e.g., system memory 230) for storing in buffer memory 334, and a write circuit that forwards data from buffer memory 334 to a target component (e.g., system memory 230). In one embodiment, the direct memory access nature of data processor DMA 320 may allow data processor DMA 320 to fetch and write data directly from a source (e.g., system memory 230) without the involvement of CPU 208. Buffer memory 334 may be a direct memory access buffer that stores data of a machine learning model of device 100 without the involvement of CPU 208.

Neural Processor (NP) controller 350 is a control circuit that performs various operations to control the overall operation of neural processor circuit 218. NP controller 350 may interface with CPU 208, program components of neural processor circuit 218 by setting register in the components and perform housekeeping operations. NP controller 350 may also initialize components in neural processor circuit 218 when neural processor circuit 218 is turned on.

### Example Neural Engine Architecture

FIG. 4A is a block diagram of neural engine 314, according to one embodiment. Neural engine 314 performs various operations to facilitate machine learning such as convolution, tensor product, and other operations may involve heavy computation. For this purpose, neural engine 314 receives input data 322, performs multiply-accumulate operations (e.g., convolution operations) on input data 322 based on stored kernel data, performs further post-processing operations on the result of the multiply-accumulate operations, and generates output data 328. Input data 322 and/or output data 328 of neural engine 314 may be of a single channel or span across multiple channels.

Neural engine 314 may include, among other components, input buffer circuit 402, computation core 416, neural engine (NE) control 418, kernel extract circuit 432, accumulator circuit 414 and output circuit 424. Neural engine 314 may include fewer components than what is illustrated in FIG. 4A or include further components not illustrated in FIG. 4A.

Input buffer circuit 402 is a circuit that stores a subset of the data of neural processor circuit 218 as the subset of data is received from a source. The source may be data processor circuit 318, planar engine 340, or another suitable component. Input buffer circuit 402 sends an appropriate segment 408 of data for a current task or process loop to computation core 416 for processing. Input buffer circuit 402 may include a shifter 410 that shifts read locations of input buffer circuit 402 to change segment 408 of data sent to computation core 416. By changing segments of input data provided to computation core 416 via shifting, neural engine 314 can perform multiply-accumulate for different segments of input data based on a fewer number of read operations. In one or more embodiments, the data of neural processor circuit 218 includes data of difference convolution groups and/or input channels.

Kernel extract circuit 432 is a circuit that receives kernel data 326 from kernel DMA 324 and extracts kernel coefficients 422. In one embodiment, kernel extract circuit 432 references a lookup table (LUT) and uses a mask to reconstruct a kernel from compressed kernel data 326 based on the LUT. The mask indicates locations in the reconstructed kernel to be padded with zero and remaining locations to be filled with numbers. Kernel coefficients 422 of the reconstructed kernel are sent to computation core 416 to populate register in multiply-add (MAD) circuits of computation core 416. In other embodiments, kernel extract circuit 432 receives kernel data in an uncompressed format and the kernel coefficients are determined without referencing a LUT or using a mask.

Computation core 416 is a programmable circuit that performs computation operations. For this purpose, computation core 416 may include MAD circuits MADO through MADN and a post-processor 428. Each of MAD circuits MADO through MADN may store an input value in segment 408 of the input data and a corresponding kernel coefficient in kernel coefficients 422. The input value and the corresponding kernel coefficient are multiplied in each of MAD circuits to generate a processed value 412.

Accumulator circuit 414 is a memory circuit that receives and stores processed values 412 from MAD circuits. The processed values stored in accumulator circuit 414 may be sent back as feedback information 419 for further multiply and add operations at MAD circuits or sent to post-processor 428 for post-processing. Accumulator circuit 414 in combination with MAD circuits form a multiply-accumulator (MAC) 404. In one or more embodiments, accumulator circuit 414 may have subunits (or batches) where each subunit sends data to different components of neural engine 314. For example, during an operating cycle, data stored in a first subunit of accumulator circuit 414 is sent to MAC 404 while data stored in a second subunit of accumulator circuit 414 is sent to post-processor 428.

Post-processor 428 is a circuit that performs further processing of values 412 received from accumulator circuit 414. Post-processor 428 may perform operations including, but not limited to, applying linear functions (e.g., Rectified Linear Unit (ReLU)), normalized cross-correlation (NCC), merging the results of performing neural operations on 8-bit data into 16-bit data, and local response normalization (LRN). The result of such operations is output from post-processor 428 as processed values 417 to output circuit 424. In some embodiments, the processing at post-processor 428 is bypassed. For example, the data in accumulator circuit 414 may be sent directly to output circuit 424 for access by other components of neural processor circuit 218.

NE control 418 controls operations of other components of neural engine 314 based on the operation modes and parameters of neural processor circuit 218. Depending on different modes of operation (e.g., group convolution mode or non-group convolution mode) or parameters (e.g., the number of input channels and the number of output channels), neural engine 314 may operate on different input data in different sequences, return different values from accumulator circuit 414 to MAD circuits, and perform different types of post-processing operations at post-processor 428. To configure components of neural engine 314 to operate in a desired manner, NE control 418 sends task commands that may be included in information 419 to components of neural engine 314. NE control 418 may include a rasterizer 430 that tracks the current task or process loop being processed at neural engine 314.

Input data is typically split into smaller pieces of data for parallel processing at multiple neural engines 314 or neural engines 314 and planar engine 340. A set of data used for a convolution operation may be referred to as a convolution group, which can be split into multiple smaller units. The hierarchy of smaller units (segments) may be convolution groups, slices, tiles, work units, output channel groups, input channels (Cin), sub-Cins for input stride, etc. For example, a convolution group may be split into several slices; a slice may be split into several tiles; a tile may be split into several work units; and so forth. In the context of neural engine 314, a work unit may be a segment of the input data, such as data processed by planar engine 340 or data processed during a prior operating cycle of neural engines 314 having a size that produces output values that fit into accumulator circuit 414 of neural engine 314 during a single operating cycle of computation core 416. In one case, the size of each work unit is 256 bytes. In such embodiments, for example, work units can be shaped to one of 16×16, 32×8, 64×4, 128×2 or 256×1 datasets. In the context of planar engine 340, a work unit may be (i) a segment of input data, (ii) data from neural engine 314 or (iii) data from a prior operating cycle of planar engine 340 that can be processed simultaneously at planar engine 340.

Rasterizer 430 may perform the operations associated with dividing the input data into smaller units (segments) and regulate the processing of the smaller units through MACs 404 and accumulator circuit 414. Rasterizer 430 keeps track of sizes and ranks of segments of the input/output data (e.g., groups, work units, input channels, output channels) and instructs the components of a neural processor circuit 218 for proper handling of the segments of the input data. For example, rasterizer 430 operates shifters 410 in input buffer circuits 402 to forward correct segments 408 of input data to MAC 404 and send the finished output data 328 to data buffer memory 334. Other components of neural processor circuit 218 (e.g., kernel DMA 324, buffer DMA 320, buffer memory 334, planar engine 340) may also have their corresponding rasterizers to monitor the division of input data and the parallel computation of various segments of input data in different components.

Output circuit 424 receives processed values 417 from post-processor 428 and interfaces with data processor circuit 318 to store processed values 417 in data processor circuit 318. For this purpose, output circuit 424 may send out output data 328 in a sequence or a format that is different from the sequence or format in which the processed values 417 are processed in post-processor 428.

The components in neural engine 314 may be configured during a configuration period by NE control 418 and neural task manager 310. For this purpose, neural task manager 310 sends configuration information to neural engine 314 during the configuration period. The configurable parameters and modes may include, but are not limited to, mapping between input data elements and kernel elements, the number of input channels, the number of output channels, performing of output strides, and enabling/selection of post-processing operations at post-processor 428.

### Example Streaming Convolution

Embodiments of the present disclosure relate to performing streaming convolution operations. In the streaming convolution operations, multiple layers of a CNN execute convolution operations in parallel, either physically or virtually. Each layer may stream the most recent computed results immediately to the next convolutional layer. Additionally, buffers associated with each layer may store only a part of input data as needed for its convolution operations, instead of the entire input tensor (as it would be done in the layer-by-layer inference). Hence, the memory footprint required for streaming convolution operations becomes equal to a sum of tensor buffers used for storage of partial input tensors. On the other hand, the memory footprint required for the layer-by-layer inference depends on a layer that requires the largest total memory size to store input and output tensors simultaneously, which can be substantially larger than the required memory footprint for the streaming convolutions. Furthermore, performing convolution operations in a streaming manner can also improve an overall latency of the CNN. In the case of streaming convolution operations, a first output element (e.g., pixel value) of an output tensor of the CNN can be computed as soon as enough input data is fed to a neural engine circuit. Hence, a first-pixel-to-first-pixel latency of the CNN implemented at the neural engine circuit as streaming convolution operations can be significantly better compared to a first-pixel-to-first-pixel latency of a CNN implemented at a neural engine circuit as layer-by-layer convolution operations.

FIG. 4B illustrates an example convolution operation performed in a streaming manner at neural engine 314, according to one embodiment. The example convolution operation of FIG. 4B is a convolution of kernel coefficients 422 of size 3 by 3 by 1 with input data 322 (e.g., input tensor) of size 10 by 10 by 1 (e.g., monochrome image data), which generates output data 328 (e.g., output tensor) of size 10 by 10 by 1. The example convolution operation of FIG. 4B can be a convolution operation of one convolution layer out of multiple convolution layers in a CNN. Segment 408 of the input data may stream in from a previous layer (e.g., in raster-scan, left-to-right and then top-to-bottom). Alternatively, segment 408 of the input data may be received from system memory 230 or from image signal processor 206. To compute an output element 434 in output data 328, neural engine 314 would only process segment 408 of the input data. Thus, only segment 408 of the input data corresponding to a partial input tensor (e.g., two rows and two input elements of input data 322) may be stored in, e.g., buffer memory 334 to generate output element 434.

In the next computational cycle, a new input element of input data 322 would arrive (e.g., from buffer memory 334) as being generated from the previous layer, and consequently, neural engine 314 would compute a next output element of output tensor 328. However, a size of the partial input tensor stored in buffer memory 334 does not change, and older input element(s) of input data 322 can be evicted from buffer memory 334 since the older input element(s) of input data 322 are not used for processing again. Hence, for the streaming convolution operations, only the partial input tensor (e.g., two rows and two input elements of input data 322) may be stored in buffer memory 334, instead of buffering the entire input data 322.

FIG. 5 illustrates an example streaming inference 500 performed on multiple convolution layers, according to one embodiment. Streaming inference 500 may comprise multiple sets of convolution operations, each set of convolution operations being performed on a respective layer 505(1), 505(2), . . . , 505(N). Layer 505(1) may be a layer of the lowest hierarchy, and layer 505(N) may be a layer of the highest hierarchy. And layer 505(n+1) may be a layer of a higher hierarchy than layer 505(n), n=1, 2, . . . , N−1. Neural engine 314 may perform first convolution operations on a first input tensor (e.g., input data 322) of layer 505(1) to generate a first output tensor. Neural engine 314 may further perform second convolution operations on a second input tensor of layer 505(2) at a higher hierarchy than layer 505(1) to generate a second output tensor, the second input tensor corresponding to the first output tensor. And (e.g., for N>2), neural engine 314 may perform the N-th convolution operations on an N-th input tensor of a layer 505(N) at a higher hierarchy than layer 505(N−1) to generate output data 328, the N-th input tensor corresponding to the (N−1)-th output tensor.

Each output tensor of a respective layer 505(n) (n=1, 2, . . . , N−1) is not computed in a layer-by-layer manner, but instead a partial output tensor is computed by layer 505(n) before starting convolution operations of a next layer 505(n+1) using the partial output tensor generated by layer 505(n) as an input into layer 505(n+1). Partial tensors 510(1) through 510(N) may be processed (or generated) followed by processing (or generating) partial tensors 515(1) through 515(N). That is processing (or generating) partial tensors 510(2) through 510(N) may be performed before processing partial tensor 515(1). Partial tensors 510(1) through 510(N) may correspond to a first pass through N layers of streaming inference 500, and partial tensors 515(1) through 515(N) may correspond to a second pass through N layers of streaming inference 500 subsequent to the first pass.

### Example Neural Task Manager for Streaming Convolution

FIG. 6A is a block diagram of neural task manager 310, according to one embodiment. Neural task manager 310 may store and manage a list of task descriptors for performing streaming convolution operations at one or more neural engines 314, such as streaming inference 500. In some embodiments, compiler 240 generates the list of task descriptors, and stores the generated lists of task descriptors in, e.g., a task file. The task file may be stored in system memory 230, persistent storage 228, buffer memory 334, some other non-transitory computer readable storage media of device 100, or some combination thereof. Alternatively, a hardware component of neural processor circuit 218 (e.g., NP controller 350, data control circuit 332 or some other circuit) may generate the list of task descriptors. Neural task manager 310 may include a task DMA 604, a task memory 606 coupled to task DMA 604 (e.g., via a multiplexer 612), and a task manager controller 610 coupled to task DMA 604 (e.g., via multiplexer 612). Neural task manager 310 may include fewer components than what is illustrated in FIG. 6A or include further components not illustrated in FIG. 6A.

Task DMA 604 may load the list of task descriptors from, e.g., system memory 230, persistent storage 228, buffer memory 334, some other non-transitory computer readable storage media of device 100, or some combination thereof. During each computational cycle (e.g., clock cycle), task DMA 604 may receive data 602 including at least one task descriptor. Each task descriptor may identify a respective set of convolution operations of one or more tensor layers in a CNN.

When task DMA 604 reads new data 602 (e.g., from system memory 230), a header of new data 602 may include information regarding whether a payload of new data 602 includes a task descriptor. In case when the payload of new data 602 includes a task descriptor, the header of new data 602 may further include an address 614 where the payload of new data 602 (e.g., task descriptor 616) should be stored in task memory 606. In such case, task DMA 604 may send, to task memory 606, task descriptor 616 and address 614 where task descriptor 616 should be stored in task memory 606. Information about address 614 may be provided to task memory 606, e.g., via multiplexer 612 as address 618.

Task memory 606 may store the list of task descriptors. During a computational cycle (e.g., clock cycle), task memory 606 may receive one or more task descriptors 616 from task DMA 604, and store one or more task descriptor 616 in task memory 606 at one or more addresses 618. Task memory 606 may also be coupled to one or more control registers of neural engine 314 (e.g., register(s) of NE control 418). Task memory 606 may receive first data 622 from the one or more control registers, and use received first data 622 to update a corresponding task descriptor in task memory 606 after each task is finished. Additionally or alternatively, task memory 606 may pass second data 622 to the one or more control registers with information about a particular task descriptor in task memory 606 for configuring neural engine 314 to perform a next task associated with the particular task descriptor. Task memory 606 may be embodied as any type of memory including, for example, DRAM, SDRAM, DDR, RDRAM, SRAM or a combination thereof. A size of task memory 606 may be large enough to hold, e.g., tens of task descriptors. A size of each task descriptor may be, e.g., approximately 120 bytes, and a size of task memory 606 may be, e.g., approximately 5 Kbytes or less than 10 Kbytes.

Task manager controller 610 may control operations of task DMA 604 and task memory 606. Task manager controller 610 may further configure neural engine 314 for execution of each task represented by each task descriptor stored in task memory 606. Task manager controller 610 may control operations of task DMA 604 by throttling task DMA 604 when there are still unprocessed task descriptors stored inside task memory 606. When task memory 606 becomes empty, task manager controller 610 may send a request signal 634 to task DMA 604 to read next data 602 from an external source (e.g., system memory 230).

Task manager controller 610 may be responsible for starting execution of a task, and for updating a corresponding task descriptor in task memory 606 after the task is executed. Task manager controller 610 may start reading task descriptor from task memory 606 one by one. To start executing the task, task manager controller 610 may read an index (or task index). Then, task manager controller 610 may generate, using index, a read address 628 for reading corresponding data 622 from the corresponding task descriptor in task memory 606 identified by index. Data 622 read from the corresponding task descriptor may be used to update the one or more control registers of neural engine 314 (e.g., register(s) of NE control 418) to prepare neural engine 314 for execution of the task.

Upon execution of the task, task manager controller 610 may also update one or more parameters in the corresponding task descriptor with data 636 read from register(s) of neural engine 314 (e.g., register(s) of NE control 418). Data 636 received by task manager controller 610 may further include information that the execution of the task is done. Task manager controller 610 may update the corresponding task descriptor in task memory 606 with an address 630 of partial tensor data for usage by a next task represented by a next task descriptor. Task manager controller 610 may provide updated address 630 to the corresponding task descriptor as part of information within address 618 provided to task memory 606 via multiplexer 612 by activating a select signal 632.

This step helps updating the corresponding task descriptor in task memory 606 to be ready for the next time when the next task identifying the corresponding task descriptor will be executed for the additional number of rounds, and consequently, minimizing the amount of information each task descriptor should contain.

In some embodiments, each task description further includes one or more subtask descriptors, and each task is further divided into one or more subtasks. In some embodiments, each subtask is a subset of elements in a same tensor layer. In some embodiments, each subtask is a single element of a particular tensor layer.

FIG. 6B illustrates an example task memory 606 in neural task manager 310, according to one embodiment. Task memory 606 may store a list of task descriptors, e.g., task descriptors 602(1), 602(2), . . . , 602(N), where N is a number of convolution layers (e.g., in streaming inference 500 in FIG. 5). Each task descriptor 602(n) (n=1, 2, . . . , N) may thus identify a respective set of convolution operations of a respective convolution layer. Task descriptor 602(n) may include an input size identifier (ID) 604(n), an output size ID 606(n), a kernel size ID 608(n), and one or more pointers 610(n), n=1, 2, . . . , N. Task descriptor 602(n) may include some additional fields not shown in FIG. 6B. Alternatively, some of the fields of task descriptor 602(n) may be grouped into a single field in task descriptor 602(n). Input size ID 604(n) may identify a size of a partial input tensor to be used for a next subset of convolution operations on a corresponding portion of the n-th layer. Output size ID 606(n) may identify a size of a partial output tensor to be generated by the next subset of convolution operations. Kernel size ID 608(n) may identify a size of a kernel to be used for the next subset of convolution operations. Pointer(s) 610(n) may include data for one or more registers in neural engine 314 (e.g., register(s) in NE control 418) for configuring neural engine 314 to execute the next subset of convolution operations, such as information about an address of the partial input tensor in buffer memory 334 used for the next subset of convolution operations.

### Example Architecture of Compiler

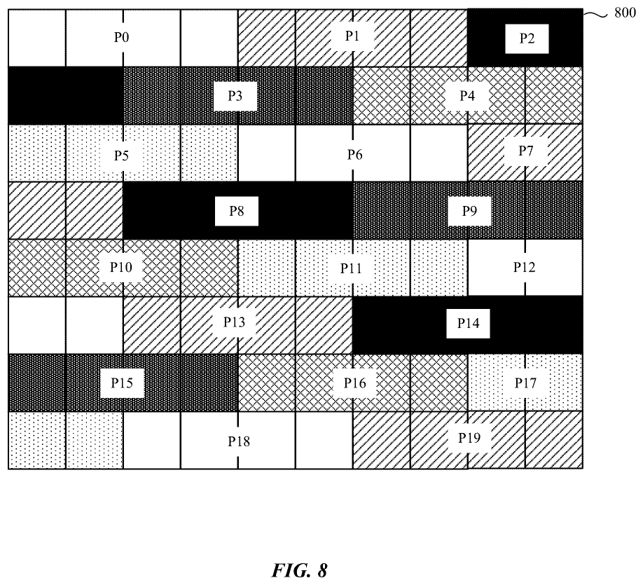

FIG. 7 is a block diagram of compiler 240 that may be implemented at a processor, such as a system processor of a device, e.g., CPU 208 and/or GPU 220, of device 100. The compiler 240 includes tensor divider 702, dependency identifier 704, initial task scheduler 706, buffer allocator 708, task descriptor generator 712, metrics generator 710, task coalescer 714, and update task scheduler 716. The tensor divider 702 spatially segments a tensor into a plurality of partitions. In some embodiments, the spatial segmentation of the tensors includes segmenting the tensors in a raster scan fashion. Additional details about spatial segmentation are further discussed below with respect to FIG. 8.

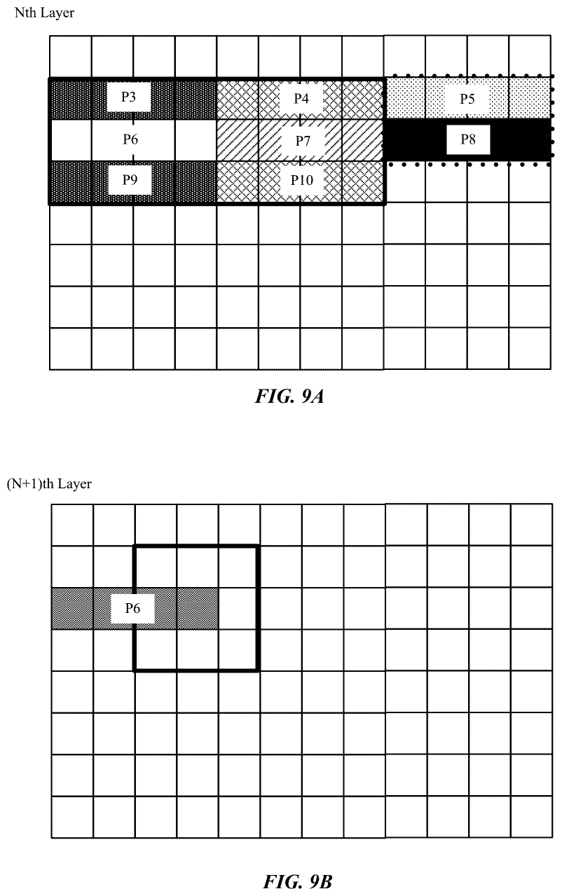

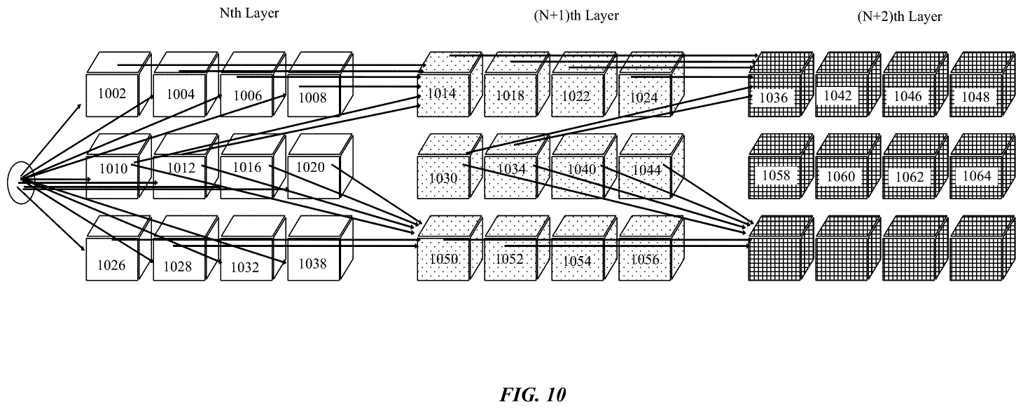

Dependency identifier 704 identifies dependencies of the partitions in the tensors. In some embodiments, dependency identifier 704 generate a dependency graph representing the identified dependencies of the partitions, as a result of its processing. Additional details about identifying dependencies of partitions are further discussed below with respect to FIGS. 9A-9B and 10.

Initial task scheduler 706 assigns each partition to a task and schedules the resulting tasks based on the dependency graph to perform neural network operation in a streaming manner. In others embodiments, initial task scheduler 706 may assign a preset number of partitions to a single task. The preset number may be determined, for example, so that data associated with the preset number of partitions do not exceed a logical size unit of buffer memory 334 that may be accessed simultaneously for read or write operation.

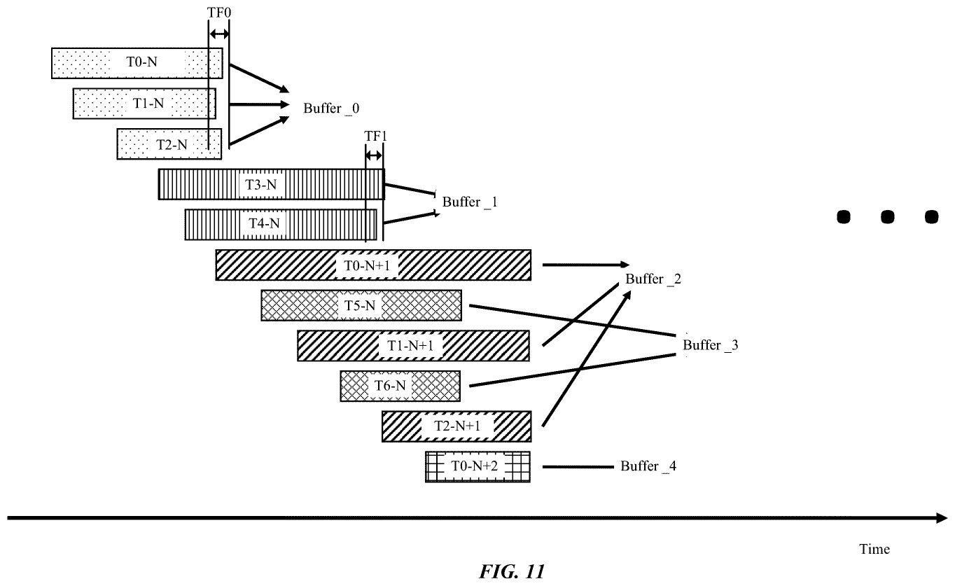

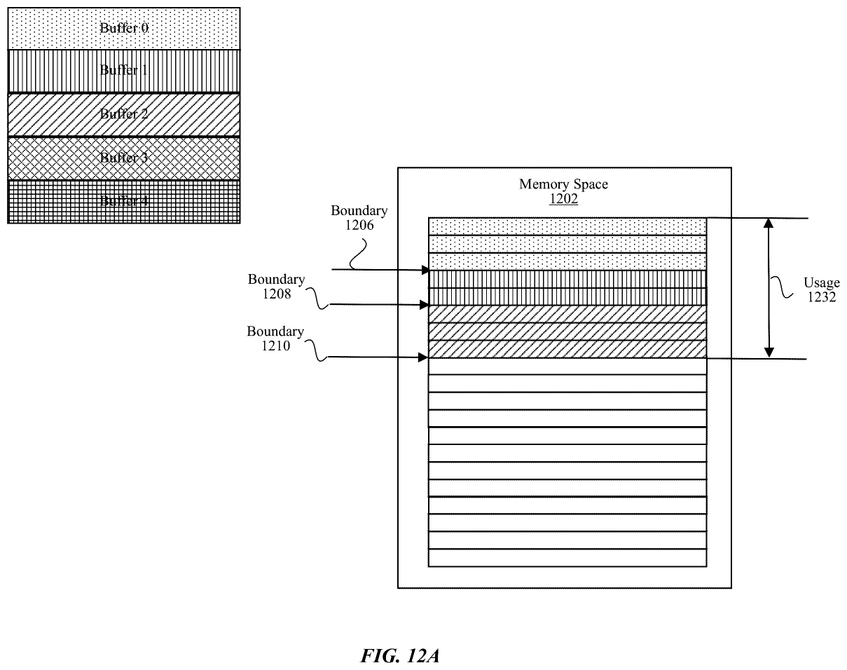

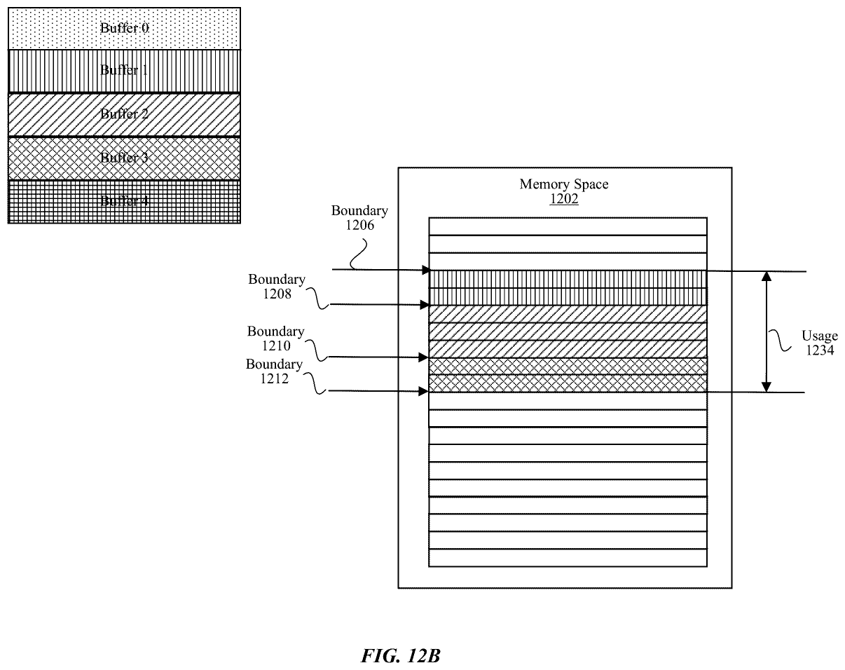

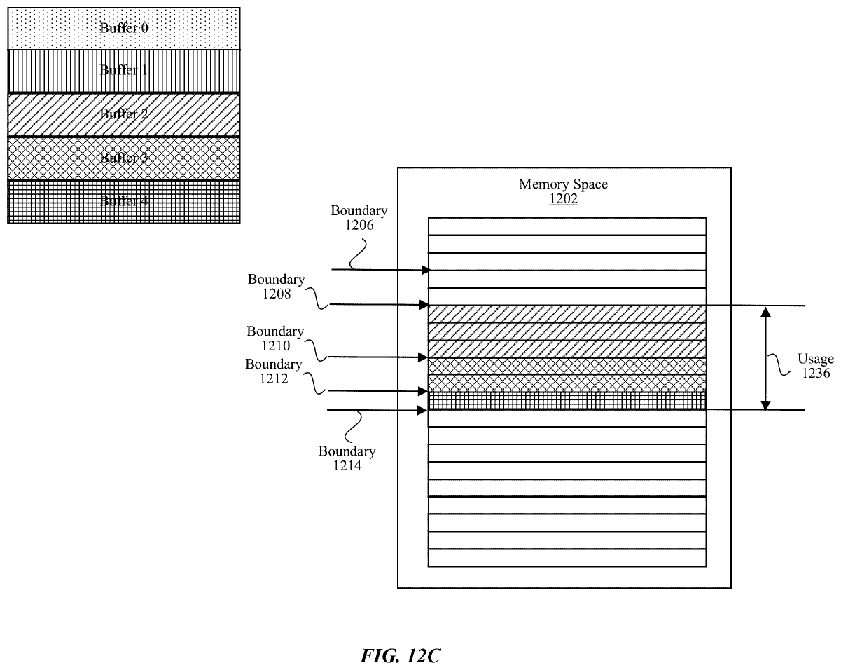

Buffer allocator 708 allocates memory space in buffer memory 334 to the tasks. The tasks are grouped into a plurality of subsets, for example, based on timing constraints associated with completion times. A subset of tasks of completion times within a predetermined time are allocated the same portion of buffer memory 334, such that the entire portion of memory may be released after the subset of tasks is completed. In this way, the subset of tasks occupy the portion of buffer memory for a shortened amount of time, and be flushed when faster to make space for subsequent tasks. Additional details about buffer allocation are further discussed below with respect to FIGS. 11 and 12A-12C.

Tasks descriptor generator 712 generates task descriptors for each task. During runtime, the tasks descriptor may be loaded to neural task manager 310 in order to configure components of neural processor circuit 218 to perform neural network operations in a streaming manner.

Metrics generator 710 determines one or more metrics indicating hardware performance of neural processor circuit 218 when a particular task schedule is deployed and executed on neural processor circuit 218. The metrics may indicate a footprint of memory space in buffer memory 334 utilized for performing the compiled operations by neural processor circuit 218. Alternative or additional metrics such as total completion time of the complied operations, power consumption and/or accumulated on-times of neural engines 314 may also be generated.

Task coalescer 714 coalesces a plurality of tasks into a fewer number of tasks to improve one or more metrics determined by the metrics generator 710. The tasks being combined by task coalescer 714 may be associated with partitions of a tensor that are adjacent or consecutive. When memory footprint is used as the metrics, for example, the coalescing may be performed to increase memory usage of buffer memory 334 up to a predetermined amount by increasing the size of updated tasks generated by coalescing the tasks. the coalescing process may be repeated multiple times until one or more criteria are satisfied (e.g., a maximum memory footprint is larger than a certain size). In certain cases, task coalescer 714 may reduce a number of partitions in each task, which is a reverse coalesce process. For example, when the memory footprint of the complied operation exceeds a certain percentage of space in buffer memory 334, the number of partitions in each task may be reduced.

The components of compiler 240 as illustrated in FIG. 7 is merely illustrative. Compiler 240 may include additional instruction modules or firmware module to perform additional functions or omit certain components (e.g., metrics generator 710, task coalescer 714 and update task scheduler 716).

### Example Segmentation of Tensor and Memory Allocation

FIG. 8 illustrates an example of spatial segmentation of tensor 800, according to one embodiment. Tensor 800 of FIG. 8 is a 10×8 matrix including 10 columns and 8 rows. In one or more embodiments, tensor 800 may be partitioned in a raster scan fashion with each partition including the same number of consecutive elements. As illustrated in FIG. 8, tensor 800 is segmented into 20 partitions P0-P19 in a raster scan fashion (e.g., in a zigzagged manner from left to right, and top to bottom) where each partition includes four consecutive elements. For example, first partition P0 includes a first four elements in a first row of the tensor 800, second partition P1 includes a second four elements in the first row of the tensor 800, third partition P2 includes a last two elements in the first row and a first two elements in the second row of the tensor 800, and so forth.

The direction of raster scan for segmenting tensor 800 may coincide with the sequence in which the elements of tensor 800 is generated in an operation prior to operations at neural processor 218. For example, tensor 800 may represent image pixels captured by image sensor 202, and processed by image signal processor 206. In such case, image signal processor 206 may generate processed pixels in a raster fashion that coincides with the sequence in which the elements are provided to and processed by neural processor circuit 218. In this way, the amount of memory to buffer the elements of tensor 800 for processing at neural processor circuit 218 may be reduced.

Partitions in a same tensor layer may be subject to dependency. In some embodiments, each partition in the same tensor layer is processed sequentially. For example, P1 is to be processed before P2, P2 is to be processed before P3, and so forth. Further, the different partitions in different layers of tensor also have certain dependency requirements. For example, when a next tensor layer is generated based on convolution computations on elements in a current layer, such dependency requirements are based on a convolution kernel. Furthermore, in addition to the dependency requirements associated with elements and convolution kernel, here, the dependency requirements are further associated with partitions, each including a plurality of elements.

FIGS. 9A and 9B illustrate an example of dependency relationship among partitions in an Nth layer tensor and a partition in an (N+1)th layer tensor, according to one embodiment. FIG. 9A illustrates elements in Nth layer. FIG. 9B illustrates elements in (N+1)th layer. To process partition P6 in (N+1)th layer (shown in FIG. 9B), each of the four elements in partition P6 are read. Assuming a convolution kernel being 3×3, each of the four elements P6 of the (N+1)th layer involves reading and processing of nine elements from the Nth layer. As such, to process P6, a 5×3 sub-matrix of elements in Nth layer (that belongs to partitions P3, P4, P6, P7, P9, and P10 in Nth layer) is read. Additionally, to process the elements in partition P6, the elements in P5 is read first; and to process the elements in partition P9, the elements in partition P8 is read first. As such, dependencies of partition P6 in (N+1)th layer include partitions P3-P10 in Nth layer. In some embodiments, a dependency graph may be generated based on the identified dependencies among partitions of different tensor layers.

FIG. 10 illustrates an example dependency graph representing dependency relationships among partitions or tasks in multiple tensor layers according to one embodiment. As illustrated in FIG. 10, the multiple tensor layers include an Nth layer tensor, an (N+1)th layer tensor, and an (N+2)th layer tensor. Each of the Nth layer, the (N+1)th layer, and the (N+2)th layer tensors includes a plurality of tasks. Each task corresponds one or more partitions. For example, in the Nth layer, there are tasks 1002, 1004, 1006, 1008, 1010, 1012, 1016, 1020, 1026, 1028, 1032, and 1038, and so on and so forth. The dependency relationships are represented by lines linking between different tasks. For example, there are multiple lines linking between tasks 1002, 1004, 1006, 1008, 1010, 1012 in the Nth layer and task 1014 in the (N+1)th layer. As such, tasks 1014 cannot be completed until results from tasks 1002, 1004, 1006, 1008, 1010, 1012 are all completed.

In each layer, the tasks may be performed sequentially although tasks in different layers may be performed simultaneously in a streaming manner. For example, in the Nth layer, task 1002 needs to be performed before task 1004, and task 1004 needs to be performed before task 1006, and so forth. As such, tasks 1002, 1004, 1006, 1008, 1010, 1012, 1016, 1020, 1026, 1028, 1032, 1038 in the Nth layer tensor are computed sequentially. Similarly, tasks 1014, 1018, 1022, 1024, 1030, 1034, 1040, 1044 in the (N+1)th layer are also computed sequentially. For example, after tasks 1002, 1004, 1006, 1008, 1010, 1012 in the Nth layer tensor are computed sequentially, tasks 1014, 1018, 1022, 1024, 1030, 1034 in the (N+1)th layer may then be computed sequentially. At the same time, tasks 1016, 1020, 1026, 1028, 1032, 1038 in the Nth layer may also be computed sequentially.

The exact order for performing the tasks in the Nth layer or the (N+1)th layer may be determined by the initial task scheduler 706 or update task scheduler 716 of the compiler 240. For example, in some embodiments, task 1002 in the Nth layer and task 1014 in the (N+1)th layer may be scheduled to be performed simultaneously; task 1004 in the Nth layer and task 1018 in the (N+1)th layer may be scheduled to be performed simultaneously, and so forth.

After tasks 1014, 1018, 1022, 1024, 1030, 1034 in the (N+1)th layer are completed, tasks 1036, 1042, 1046, 1048, 1058, 1060, 1062, 1064 in the (N+2)th layer may be performed sequentially. At the same time, tasks 1040, 1044, 1050, 1052, 1054, 1056. in the (N+1)th layer may also be performed sequentially. Again, the exact order for performing the tasks in the Nth layer or the (N+1)th layer may be determined by the initial task scheduler 706 or update task scheduler 716 of the compiler 240. For example, task 1036 in the (N+2)th layer, task 1040 in the (N+1)th layer, and task 1038 in the Nth layer may be performed simultaneously; task 1042 in the (N+2)th layer and task 1044 in the (N+1)th layer may be performed simultaneously, and so on and so forth. This process can repeat as many times as necessary until all the tasks in each of the tensor layers are completed.

When the different tasks are performed according to the task schedule, partitions associated with the tasks are loaded into portions of the memory buffer 334. After certain tasks are completed, a portion of the memory buffer that is used to store the tasks is released to make space available for subsequent tasks. In some embodiments, multiple tasks scheduled for completion within a predetermined timeframe are allocated to the same portion of buffer memory 334 to efficiently utilize the buffer memory. For example, in some embodiments, the tasks are grouped into a plurality of subsets based on their completion times. The grouped subset of tasks are then stored in the same logical portion of buffer memory 334.

FIG. 11 illustrates an example of buffer allocation among tasks in different tensor layers according to one embodiment. As illustrated in FIG. 11, T0-N, T1-N, T2-N, T3-N, T4-N, T5-N, T6-N represent tasks in the Nth tensor layer; T0-(N+1), T1-(N+1), T2-(N+1) represent tasks in the (N+1)th tensor layer; and T0-(N+2) represents partition or task in the (N+2)th tensor layer. Each task includes one or more partitions in a particular tensor layer, and each partition includes one or more elements in the particular tensor layer. The elements in the (N+1)th layer are computed based on elements computed in the Nth layer, and elements in the (N+2)th layer are computed based on elements in the (N+1)th layer.

As illustrated in FIG. 11, tasks T0-N, T1-N, T2-N all have completion times that may or may not be identical but fall within time frame FT0. Accordingly, tasks T0-N, T1-N, T2-N tasks are allocated a same first portion of buffer memory (referred to as buffer_0), and all three tasks partially overlap in terms of processing times. Once all the tasks T0-N, T1-N T2-N are completed, the entire portion of memory buffer_0 may be released. On the other hand, tasks T3-N, T4-N have completion times that are not identical but all falling within time frame FT1. These tasks are all allocated to the same second portion of buffer memory (referred to as buffer_1). Again, tasks T0-(N+1), T1-(N+1), and T2-(N+1) are allocated a same third portion of buffer memory (referred to as buffer_2); tasks T5-N and T6-N are allocated a fourth same portion of buffer memory (referred to as buffer_3), and task T0-(N+2) is allocated a same fifth portion of buffer memory (referred to as buffer_4).

The allocation of memory as illustrated in FIG. 11 is merely illustrative. In some cases, not only the subset of tasks allocated the same portion of buffer memory but different tasks allocated in different portions of buffers, buffer_0, buffer_1, buffer_2, buffer_3, buffer_4 may also be performed partially simultaneously. Further, some tasks assigned to the same portion of the buffer memory may not overlap in terms of the execution time. For example, a smaller task may be start processing after a larger task but both may still qualify for assigning to the same portion of the buffer memory if the completion times of both tasks are within a predetermined time frame.

In some embodiments, only tasks from a same layer may be assigned a same portion of buffer memory. Alternatively, in some embodiments, tasks from different layers may also be assigned a same portion of the buffer memory.

FIGS. 12A-12C illustrate examples of allocating portions of buffer memory 334 for storing tasks corresponding to tasks shown in FIG. 11, according to one embodiment. Memory space 1202 may represent a virtual or logical memory space mapped to physical memory space of buffer memory 334. Hence, the memory space 1202 appearing contiguous in the figures may actually be non-contiguous in physical memory space of buffer memory 334.

FIG. 12A illustrates portions of memory buffer_0, buffer_1, buffer_2 allocated for storing data associated with tasks. In some embodiments, a first portion of memory buffer_0 with a boundary 1206 is first allocated for storing data of tasks T0-N, T1-N, and T2-N; after that, a second portion of memory buffer_1 with a boundary 1208 is allocated for storing data of tasks T3-N and T4-N; after that, a third portion of memory buffer_2 with a boundary 1210 is allocated for storing data of tasks T0-(N+1), T1-(N+1), and T2-(N+1). The total memory usage during such configuration is represented by patterned rows 1232.

Referring to FIG. 11, the subset of tasks T0-N, T1-N, T2-N stored in the first portion of memory (buffer_0) are completed before the subset of tasks T5-N, T6-N in the fourth portion of memory (buffer_3) starts. As such, the first portion of memory, buffer_0, may be released before the fourth portion of memory (buffer_3) is allocated. The released portion of memory may be reallocated to store data of other tasks. FIG. 12B illustrates releasing of the first portion of memory, buffer_0. After the releasing of the first portion of memory (buffer_0), a fourth portion of memory (buffer_3) with boundary 1212 is stored with data of tasks T5-N, T6-N. The total memory usage during such configuration is represented by patterned rows 234.

Again, referring back to FIG. 11, the subset of tasks T3-N and T4-N stored in the second portion of memory (buffer_1) is completed before task T0-(N+2) stored in the fifth portion of memory (buffer_4) starts. As such, the second portion of memory (buffer_1) may be released before storing data in a fifth portion of memory (buffer_4). The released portion of memory may be reallocated to store data of other tasks. FIG. 12C illustrates that the second portion of memory (buffer_1) is released. After releasing the second portion of memory (buffer_1), a fifth portion of memory (buffer_4) with boundary 1214 is allocated for storing data of tasks T0-(N+2). The total memory usage during such configuration is represented by patterned rows 1236.

This process may repeat as many times as necessary. The total memory usage 1232, 1234, 1236 fluctuates as the neural network operation proceeds. A largest memory usage 1232, 1234, 1236 may be determined as a memory footprint, which should remain below a maximum memory capacity of buffer memory 334. If the memory footprint is much smaller than the maximum memory capacity of buffer memory 334, however, task coalescer 714 coalesces tasks to increase the memory footprint and increase the efficiency of the neural network operation.

Initial task scheduler 706 generates a first task schedule with a small memory footprint with lower maximum memory usage where each task only includes a single partition. After coalescing the tasks by task coalescer, each task may include a plurality of partitions. Alternatively, initial task scheduler 706 may generate a first task schedule where a task includes two or more partitions. In such case, task coalescer 714 may coalesce tasks so that a larger number of partitions are included in a single task. If the memory footprint is excessively large, task coalescer 714 may divide a single task with multiple partitions into multiple tasks, each with fewer partitions.

### Example Processes for Compiling Streaming Operations

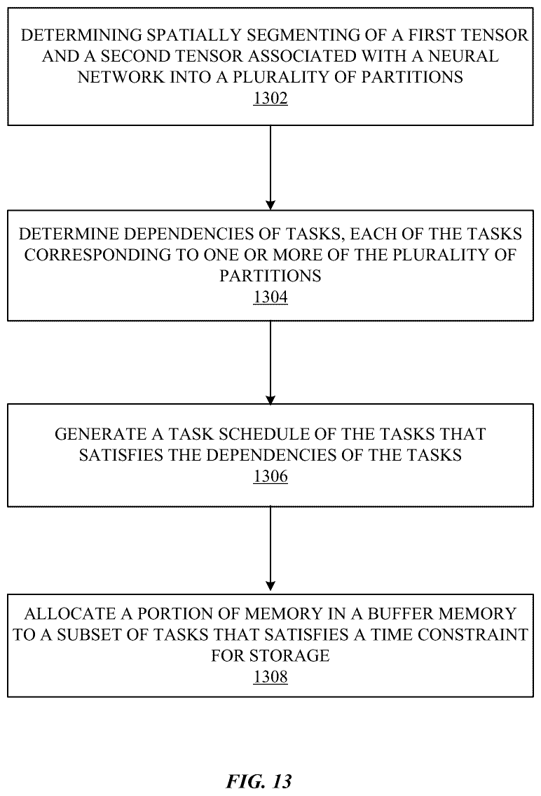

FIG. 13 is a flowchart illustrating a method of compiling operations associated with a neural network, according to one or more embodiments. The method may be performed by a processor (e.g., CPU 208) in a device that includes a neural processor circuit or by a device that does not include a neural processor circuit. In the latter case, the device may compile the tasks and send the generated task schedule to another device with the neural processor circuit.

The processor determines 1302 spatial segmenting of a first tensor and a second tensor associated with a neural network into a plurality of partitions. The second tensor is derived by performing convolution on the first tensor by the neural processor. For example, the first tensor is an Nth layer tensor, and the second tensor is an (N+1)th layer tensor. In some embodiments, the spatial segmenting of the first tensor and the second tensor into the plurality of partitions based on a raster scan fashion. Determining the spatial segmenting of the first tensor and the second tensor includes reading units of the first tensor or the second tensor of a predetermined size in the raster scan fashion. Each of the partitions may include the same number of consecutive elements in the tensor. When the tensor represents an image, the elements of the tensor may be pixels, and the pixels of the image are segmented into a plurality of partitions.

The processor determines 1304 dependencies of tasks. Each of the tasks corresponds to one or more of the plurality of partitions. In some embodiments, the dependencies are based on the dimension of a convolution kernel. As a result of determining the dependencies of tasks, a dependency graph representing the dependencies of tasks may be generated.

The processor generates 1306 a task schedule (also referred to as “a first task schedule”) of the tasks that satisfies the determined dependencies of the tasks, and allocates 1308 a subset of the tasks (also referred to as “a first subset of the tasks”) satisfying a timing constraint (also referred to as “a first timing constraint”) associated with completion times of the subset of the tasks to a same portion (also referred to as “a first portion”) of a buffer memory (e.g., buffer memory 334) in the neural processor circuit 218.

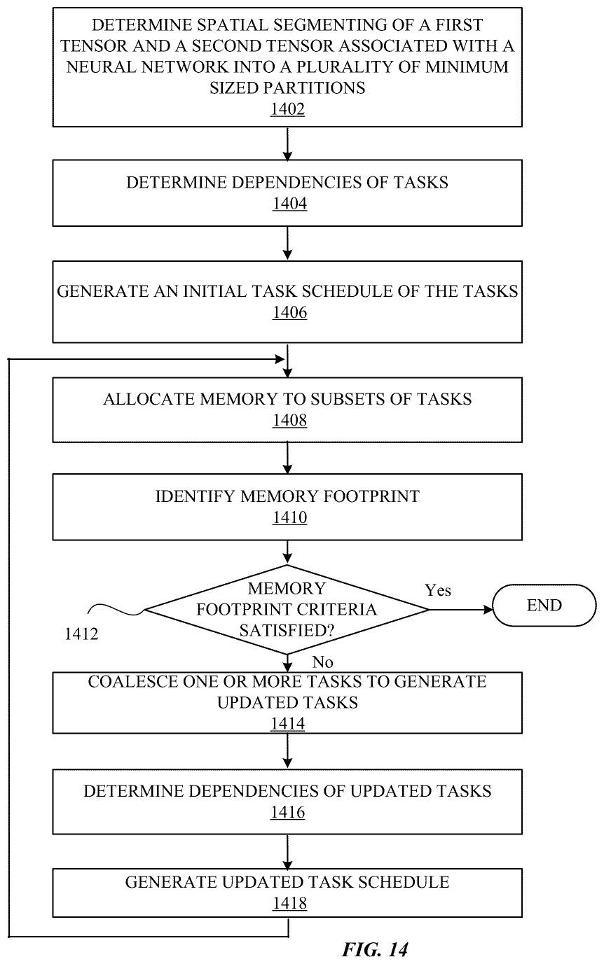

FIG. 14 is a flowchart illustrating a method of compiling operations associated with a neural network, according to one or more embodiments. The processor spatially segment 1402 a first tensor and a second tensor associated with a neural network into initial partitions, each of a size that corresponds to a number of elements in a block that can be read from or written to a buffer memory simultaneously.

The processor then determines 1404 dependencies of tasks, each of which corresponds to each of the plurality of partitions. In some embodiments, a task dependency graph is generated describing the dependencies of the tasks.

The processor then generates 1406 an initial task schedule of the tasks that satisfies the dependencies of the tasks. The processor then allocates 1408 a portion of memory (also referred to as “a first portion”) in the buffer memory to a subset of tasks that satisfies a time constraint (also referred to as “a first time constraint”) for storage. The processor may also allocate a second portion of memory in the buffer memory to a subset of tasks that satisfies a second time constraint for storage. Once the first subset or second subset of tasks are completed, the first portion or the second portion of memory is released.

The processor may identify 1410 a memory footprint of the buffer memory for executing the initial task schedule. Then it is determined 1412 whether the initial task schedule satisfies a memory footprint criteria, then the initial task schedule is determined as the final task schedule. If not, the process proceeds to coalesce 1414 tasks into fewer updated tasks. After that, the processor determines 1416 dependencies of updated tasks, and generates 1418 an updated task schedule 1418 of the updated tasks. After coalescing the tasks, a memory footprint of the updated task schedule would tend to be greater than that of the initial task schedule.

After that, the process returns to allocating 1408 memory to the updated tasks as described above, and then identifies 1410 memory footprint of the updated task schedule. If the update task schedule satisfies the memory footprint criteria, the updated task schedule is determined as the final task schedule and the process terminates. If not, the coalescing 1414 of tasks through identifying 1410 the memory footprint are repeated until the memory footprint criteria are satisfied.

Embodiments of the process as described above with reference to FIGS. 13-14 are merely illustrative. Moreover, sequence of the process may be modified or omitted. For example, the process of allocating 1408 memory and identifying 1410 may be performed simultaneously. Further, the process of determining 1412 whether memory footprint criteria is satisfied through generating 1418 an updated task schedule may be omitted.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A method for compiling neural network operations associated with a neural network, comprising:
determining spatial segmentation of a first tensor and a second tensor associated with a neural network, the spatial segmentation dividing the first tensor and the second tensor into a plurality of partitions, the second tensor derived by performing convolution on the first tensor by a neural processor;
determining dependencies of tasks, each of the tasks corresponding to one or more of the plurality of partitions;
generating a first task schedule of the tasks that satisfies the dependencies of the tasks; and
allocating a first subset of the tasks, that have completion times at the neural processor satisfying a first timing constraint, to a same first portion of a memory in the neural processor for storage.

2. The method of claim 1, wherein generating the first task schedule of the tasks further includes allocating a second subset of the tasks satisfying a second time constraint associated with completion times of the second subset of the tasks at the neural processor to a same second portion of the memory in the neural processor for storage, the first timing constraint requiring the first subset of the tasks to have completion times within a first time frame, and the second time constraint requiring the second subset of the tasks to have completion times within a second time frame.

3. The method of claim 2, wherein the tasks are performed in a streaming manner in the neural processor such that performance of least one of the tasks corresponding to a first partition in the first tensor and performance of at least one of the tasks corresponding to a second partition in the second tensor partially overlap with each other.

4. The method of claim 2, the method further comprising:
releasing the first portion of the memory after an end of the first time frame when the first subset of the tasks are completed, and
releasing the second portion of the memory after an end of the second time frame when the second subset of the tasks are completed.

5. The method of claim 2, the method further comprising:
adjusting a number of partitions in each of the tasks according to a hardware configuration of the neural processor.

6. The method of claim 5, the hardware configuration is associated with a size of a memory of the neural processor.

7. The method of claim 5, wherein adjusting the number of partitions in each of the tasks according to the hardware configuration of the neural processor includes:
coalescing two or more of the tasks to generate updated tasks;
determining dependencies of the updated tasks; and
generating a second task schedule of the updated tasks that satisfies the dependencies of the updated tasks.

8. The method of claim 7, the method further comprising:
determining a first value of a metric indicating hardware performance when the first task schedule is implemented;
determining a second value of the metric indicating hardware performance when the second task schedule is implemented;
comparing the first value and the second value to determine whether the first task schedule or the second task schedule yields a higher hardware performance; and
choosing one of the first task schedule or the second task schedule that yields the higher hardware performance for operating the neural processor.

9. The method of claim 8, wherein the metric indicates a footprint of a portion of the memory utilized for performing the tasks by the neural processor.

10. The method of claim 1, wherein determining the spatial segmenting of the first tensor and the second tensor into the plurality of partitions includes:
configuring the neural processor to read units of the first tensor or the second tensor of a predetermined size in a raster scan fashion, each of the partitions including a same number of consecutive elements.

11. The method of claim 1, wherein determining the dependencies of the tasks comprises generating a dependency graph representing the dependencies of the tasks corresponding to the plurality of partitions.

12. A non-transitory storage medium storing instruction thereon, the instructions when executed by a processor cause the processor to:
determine spatial segmentation of a first tensor and a second tensor associated with a neural network, the spatial segmentation dividing the first tensor and the second tensor into a plurality of partitions, the second tensor derived by performing convolution on the first tensor by a neural processor circuit;
determine dependencies of tasks, each of the tasks corresponding to one or more of the plurality of partitions;
generate a first task schedule of the tasks that satisfies the dependencies of the tasks; and
allocate a first subset of the tasks, that have completion times at the neural processor circuit satisfying a first timing constraint, to a same first portion of a memory in the neural processor circuit for storage.

13. The non-transitory storage medium of claim 12, wherein instructions to generate the first task schedule of the tasks includes instructions to allocate a second subset of the tasks satisfying a second time constraint associated with completion times of the second subset of the tasks at the neural processor circuit to a same second portion of the memory in the neural processor circuit for storage, the first timing constraint requiring the first subset of the tasks to have completion times within a first time frame, and the second time constraint requiring the second subset of the tasks to have completion times within a second time frame.

14. The non-transitory storage medium of claim 13, wherein the tasks are performed in a streaming manner in the neural processor circuit such that performance of least one of the tasks corresponding to a first partition in the first tensor and performance of at least one of the tasks corresponding to a second partition in the second tensor partially overlap with each other.

15. The non-transitory storage medium of claim 13, wherein the instructions further cause the processor to:
release the first portion of the memory after an end of the first time frame when the first subset of the tasks are completed, and
release the second portion of the memory after an end of the second time frame when the second subset of the tasks are completed.

16. The non-transitory storage medium of claim 13, wherein the instructions further cause the processor to:
adjust a number of partitions in each of the tasks according to a hardware configuration of the neural processor circuit, the hardware configuration associated with a size of the memory of the neural processor circuit.

17. The non-transitory storage medium of claim 16, wherein the instructions to adjust the number of partitions cause the processor to:
coalesce two or more of the tasks to generate updated tasks;
determine dependencies of the updated tasks; and
generate a second task schedule of the updated tasks that satisfies the dependencies of the updated tasks.

18. The non-transitory storage medium of claim 17, the instructions further cause the processor to:
determine a first value of a metric indicating hardware performance when the first task schedule is implemented, the metric indicating a footprint of a portion of the memory utilized for performing the tasks by the neural processor circuit;
determine a second value of the metric indicating hardware performance when the second task schedule is implemented;
compare the first value and the second value to determine whether the first task schedule or the second task schedule yields a higher hardware performance; and
choose one of the first task schedule or the second task schedule that yields the higher hardware performance for operating the neural processor circuit.

19. The non-transitory storage medium of claim 12, wherein the instructions to determine the spatial segmenting of the first tensor and the second tensor causes the processor to:
configure the neural processor circuit to read units of the first tensor or the second tensor of a predetermined size in a raster scan fashion, each of the partitions including a same number of consecutive elements.

20. An electronic device, comprising:
a system memory;
a neural processor circuit coupled to the system memory, the neural processor circuit including a memory; and
a system processor configured to:
determine spatial segmentation of a first tensor and a second tensor associated with a neural network for processing in the neural processor circuit, the spatial segmentation dividing the first tensor and the second tensor into a plurality of partitions, the second tensor derived by performing convolution on the first tensor by a neural processor;
determine dependencies of tasks, each of the tasks corresponding to one or more of the plurality of partitions;
generate a first task schedule of the tasks that satisfies the dependencies of the tasks; and
allocate a first subset of the tasks, that have completion times at the neural processor circuit satisfying a first timing constraint, to a same first portion of a memory in the neural processor circuit for storage.
